(19) United States
(12) Patent Application Publication
(10) Pub. No.: US 2009/0165890 A1
(43) Pub. Date: Jul. 2, 2009

(54) Supply and collection system for an organic hydride or liquid fuel containing an organic hydride

(76) Inventors: Akiyoshi Komura, Hitachi (JP); Kenichi Souma, Mito (JP); Takao Ishikawa, Hitachi (JP); Masafumi Noujima, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/318,192

(22) Filed: Dec. 23, 2008

(30) Foreign Application Priority Data
Dec. 27, 2007 (JP) 2007-335520

(51) Int. Cl. B67D 5/60; G06Q 50/00

(52) U.S. Cl. 141/98; 141/94; 705/28

(57) ABSTRACT

A fuel supply and collection system comprising: a delivery vehicle having a supply-fuel tank, a collection-fuel tank, a remaining supply-fuel quantity sensor for detecting a remaining fuel quantity of the supply-fuel tank, a remaining collection-fuel quantity sensor for detecting a remaining fuel quantity of the collection-fuel tank, and a display unit; a plurality of fuel stations having a supply-fuel tank, a collection-fuel tank, a remaining supply-fuel quantity sensor for detecting a remaining fuel quantity of the supply-fuel tank, and a remaining collection-fuel quantity sensor for detecting a remaining fuel quantity of the collection-fuel tank; and a central information processing center having an information processing apparatus;
wherein, the remaining supply-fuel and collection-fuel quantities of the delivery vehicle and the remaining supply-fuel and collection-fuel quantities of each fuel station are estimated in the information processing apparatus from remaining supply-fuel quantity data and remaining collection-fuel quantity data detected in the delivery vehicle and remaining supply-fuel quantity data and remaining collection-fuel quantity data detected at each of the fuel stations; supply and collection priority order of each fuel station are calculated from the estimated remaining supply-fuel and collection-fuel quantity data of each fuel station; a driving route of the delivery vehicle is determined based on the estimated remaining supply-fuel and collection-fuel quantity data of the delivery vehicle and the supply and collection priority order of each fuel station; and the determined driving route is displayed on the display unit in the delivery vehicle.

### CLAIM OF PRIORITY

The present application claims priority from Japanese patent application JP 2007-335520 filed on Dec. 27, 2007, the content of which is hereby incorporated by reference into this application.

### BACKGROUND OF THE INVENTION

1. Field of the Invention

The present invention relates to a supply and collection system for an organic hydride or a liquid fuel containing an organic hydride; the organic hydride as a storage medium for hydrogen.

2. Description of the Related Art

In order to solve energy and resource problems such as global warming, resource depletion, and energy security, hydrogen has been attracting interest as an alternative fuel to petroleum in recent years. Hydrogen, being gaseous at normal temperature and pressure, has low energy density, which causes hydrogen to require a high-density storage device for storage and transportation. One of the storage device is an organic hydride which allows chemical storage of hydrogen. For example, as shown in FIG. 9, methylcyclohexane can be broken down into toluene and hydrogen through endothermic reaction. On the other hand, toluene and hydrogen can be combined into methylcyclohexane through exothermic reaction. The organic matter which allows chemical storage of hydrogen in this way is called an organic hydride in general. The weight storage density of methylcyclohexane, toluene series, is 6.2 wt %, which is equal to or more than a high-pressure hydrogen gas of 70 MPa. Furthermore, methylcyclohexane and toluene are both liquid at normal temperature and pressure, and can be handled in the same way as gasoline; which fact gives methylcyclohexane and toluene an advantage that the existing infrastructure of gasoline can be utilized for hydrogen supply. In this case, after methylcyclohexane is supplied to users as fuel and dehydrogenated through dehydrogenation reaction, toluene as the residual liquid needs to be collected.

With regard to fuel supply and transportation, Patent Document 1, for example, proposes a system for fast, efficient fuel distribution.

Patent Document 1: Japanese Patent Application Laid-open No. 2004-359263

### SUMMARY OF THE INVENTION

Delivery systems concerning fuel supply and transportation have been studied in the past; however, in these cases of fuel supply and transportation, the fuels, after supplied to the users, are all used up, leaving no residual for collection. On the other hand, as far as an organic hydride is concerned, after the organic hydride is supplied as fuel, the residual liquid as a result of dehydrogenation reaction needs to be collected. Efficient supply and collection system have not yet been considered thoroughly for fuel such as the organic hydride which requires collection of the residual liquid (waste liquid) after its supply.

For example, here explains an easy case in which land height and transportation condition such as a traffic jam are not taken into account. When the gas mileage of a delivery vehicle is considered, a conventional fuel may be delivered via the shortest route after deciding the order of fuel stations requiring the fuel supply, since the fuel needs to be only supplied. On the other hand, when the organic hydride is involved, instead of supplying and collecting the fuel at the same time at each fuel station requiring supply and/or collection via the shortest route, if the delivery vehicle supplies all the fuel on the outward trip first then collects all the residual on the return trip, the mileage may be improved because weight of the vehicle will be lighter during the trip. In addition, if quantities of the supply and collection also are considered, there may be a case when the outward trip and the return trip should take different routes for better mileage. As discussed above, supply and collection of the organic hydride requires a different supply and collection system than conventional fuel supply systems.

An object of the present invention is to provide a fuel supply and collection system for fast, efficient supply and collection of the organic hydride or liquid fuel containing an organic hydride.

In order to achieve the above object, the present invention proposes a supply and collection system for an organic hydride or a liquid fuel containing an organic hydride comprising: a delivery vehicle having a supply-fuel tank, a collection-fuel tank, a remaining supply-fuel quantity sensor and a remaining collection-fuel quantity sensor for detecting a remaining fuel quantity in each of the fuel tanks, and a display unit; a plurality of fuel stations having a supply-fuel tank, a collection-fuel tank, a remaining supply-fuel quantity sensor for detecting a remaining fuel quantity of the supply-fuel tank, and a remaining collection-fuel quantity sensor for detecting a remaining fuel quantity of the collection-fuel tanks; and a central information processing center having an information processing apparatus;

wherein, the remaining supply-fuel and collection-fuel quantities of the delivery vehicle and the remaining supply-fuel and collection-fuel quantities of each fuel station are estimated in the information processing apparatus from remaining supply-fuel quantity data and remaining collection-fuel quantity data detected in the delivery vehicle and remaining supply-fuel quantity data and remaining collection-fuel quantity data detected at each fuel station.

In addition, supply and collection priority order of each fuel station is calculated from the estimated remaining supply-fuel and collection-fuel quantity data of each fuel station; a driving route for the delivery vehicle is finally determined based on the estimated remaining supply-fuel and collection-fuel quantity data of the delivery vehicle and the supply and collection priority order of each fuel station; and the determined driving route is displayed on the display unit in the delivery vehicle.

With regard to the supply and collection of an organic hydride, according to the present invention, the organic hydride or liquid fuel containing an organic hydride can be quickly and efficiently supplied and collected, since a driving route of a delivery vehicle is determined using remaining supply-fuel and collection-fuel quantity data of the delivery vehicle and remaining supply-fuel and collection-fuel quantity data of fuel stations.

### BRIEF DESCRIPTION OF THE DRAWINGS

FIG. 1 is a supply and collection system for an organic hydride or a liquid fuel containing an organic hydride showing a first embodiment of the present invention.

FIG. 2 is a flow chart showing the operation procedure in the first embodiment of the present invention.

FIG. 3 is a flow chart showing the operation procedure for determining the supply-fuel and collection-fuel quantities of each fuel station in the first embodiment of the present invention.

FIG. 4 is a flow chart showing the operation procedure for determining a driving route of a delivery vehicle in the first embodiment of the present invention.

FIG. 5 shows a calculation example of supply-fuel and collection-fuel quantities of each fuel station in the first embodiment of the present invention.

FIG. 6 is an example of a supply and collection route for each fuel station in the first embodiment of the present invention.

FIG. 7 is another example of a supply and collection route for each fuel station in the first embodiment of the present invention.

FIG. 8 is another supply and collection system for an organic hydride or a liquid fuel containing an organic hydride showing a second embodiment of the present invention.

FIG. 9 shows a chemical reaction formula of a typical organic hydride.

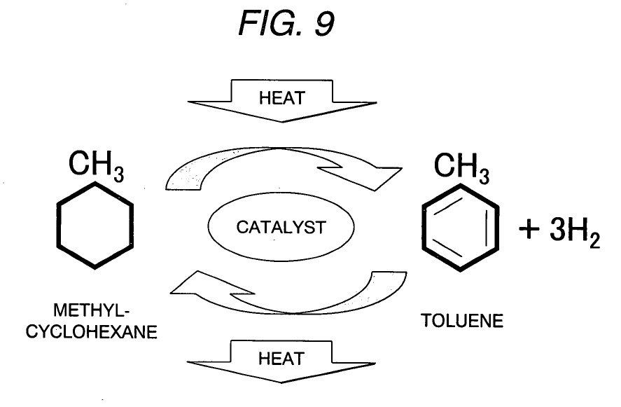

### DETAILED DESCRIPTION OF THE PREFERRED EMBODIMENTS

Organic hydride supply and collection systems according to the present invention are described in detail below based on some embodiments.

### Embodiment 1

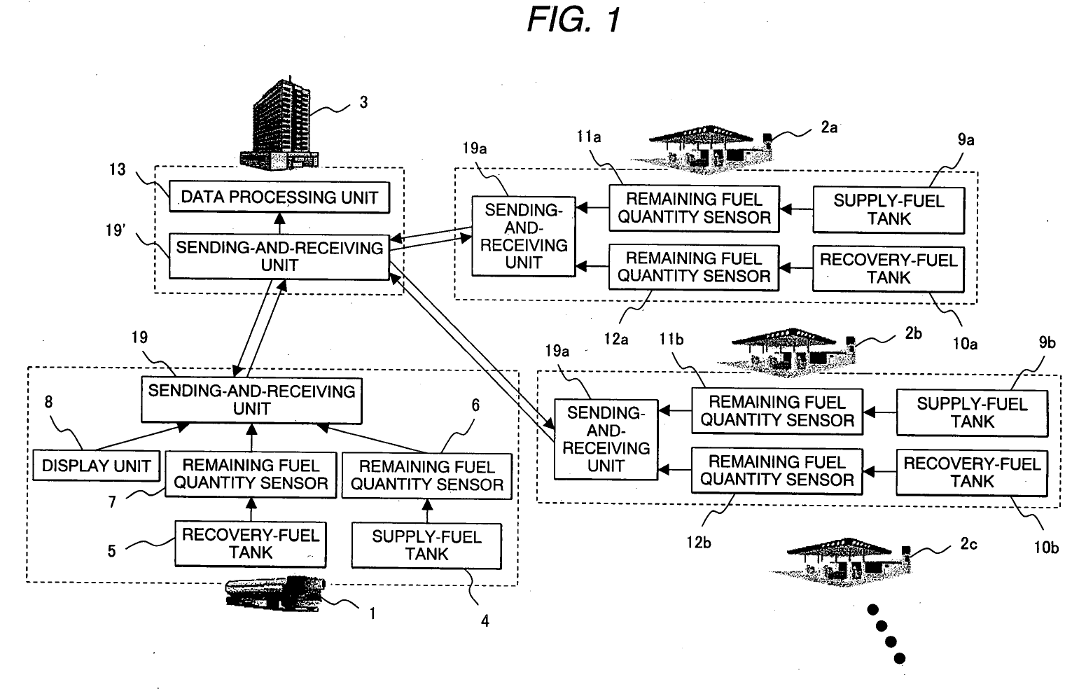

FIG. 1 is a supply and collection system for an organic hydride or liquid fuel containing an organic hydride showing the first embodiment of the present invention.

The organic hydride supply and collection system in the first embodiment comprises: a delivery vehicle 1 having a supply-fuel tank 4, a collection-fuel tank 5, a remaining supply-fuel quantity sensor 6 and a remaining collection-fuel quantity sensor 7 for detecting a remaining fuel quantity in each fuel tank 4, 5, a display unit 8, and a sending-and-receiving apparatus 19; a fuel station 2 having a supply-fuel tank 9, a collection-fuel tank 10, a remaining supply-fuel quantity sensor 11 and a remaining collection-fuel quantity sensor 12 for detecting a remaining fuel quantity in each fuel tank 9, 10, and a sending-and-receiving apparatus 19a; and a central information processing center 3 having an information processing apparatus 13 and a sending-and-receiving apparatus 19′. In this organic hydride supply and collection system, remaining supply-fuel and collection-fuel quantities of the delivery vehicle 1 and remaining supply-fuel and collection-fuel quantities of each fuel station 2 are estimated in the information processing apparatus 13 using the remaining supply-fuel quantity data and remaining collection-fuel quantity data detected in the delivery vehicle 1 and the remaining supply-fuel quantity data and remaining collection-fuel quantity data detected at each fuel station 2. Furthermore, supply and collection priority order of each fuel station 2 is calculated from the estimated remaining supply-fuel and collection-fuel quantity data of each fuel station, then a driving route for the delivery vehicle 1 is finally determined based on the estimated remaining supply-fuel and collection-fuel quantity data of the delivery vehicle 1 and the supply and collection priority order of each fuel station 2, and the determined driving route is displayed on the display unit 8 in the delivery vehicle 1. Each of the delivery vehicle 1 and fuel stations 2 has a memory unit for storing the remaining fuel quantity data detected by its own remaining fuel quantity sensors 6, 7, 11, 12, and the sending-and-receiving apparatus 19, 19a for sending the remaining fuel quantity data to the central information processing center 3 and for receiving information including the driving route determined in the central information processing center 3. In the same manner, the central information processing center 3 also has a sending-and-receiving apparatus 19′ for sending and receiving information to and from the delivery vehicle 1 and each fuel station 2. The present embodiment assumes that the data are sent and received in real time; however, a data memory unit may be added in each sending-and-receiving apparatus to have each piece of data temporarily stored in the data memory unit until it is sent or received at regular intervals.

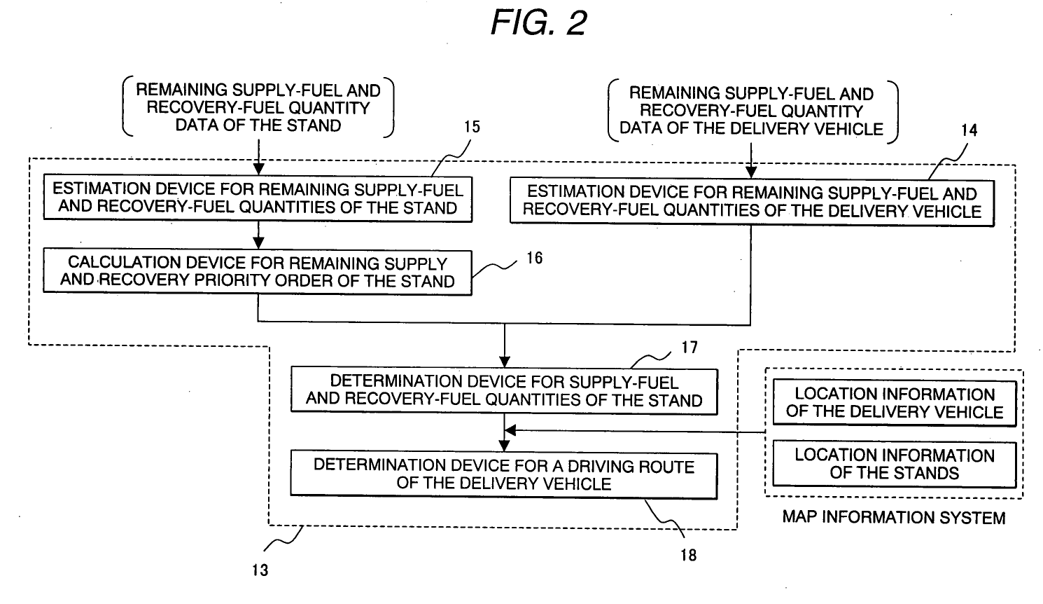

FIG. 2 is a flow chart showing the operation procedure in the first embodiment of the present invention.

The remaining supply-fuel quantity data and the remaining collection-fuel quantity data detected by the remaining supply-fuel quantity sensor 6 and the remaining collection-fuel quantity sensor 7 installed in the delivery vehicle 1 are sent to the information processing apparatus 13 in the central information processing center 3, and the remaining supply-fuel and collection-fuel quantities of the delivery vehicle 1 are estimated by an estimation device for remaining supply-fuel and collection-fuel quantities 14. In the same manner, the remaining supply-fuel quantity data and the remaining collection-fuel quantity data detected by the remaining supply-fuel quantity sensor 11 and the remaining collection-fuel quantity sensor 12 installed in each fuel station 2 are sent to the information processing apparatus 13 in the central information processing center 3, and the remaining supply-fuel and collection-fuel quantities of each fuel station 2 are estimated by an estimation device 15 for remaining supply-fuel and collection-fuel quantities. Now, from the estimated remaining supply-fuel and collection-fuel quantity data of each fuel station, priority order for supplying and/or collecting the fuels at each fuel station is calculated for each supply and collection by a calculation device 16 for supply and collection priority order of the fuel station. In addition, based on the estimated remaining supply-fuel and collection-fuel quantity data of the delivery vehicle and the supply-fuel and collection-fuel priority order data of each fuel station, the fuel quantities to be supplied and collected at each fuel station are determined by a determination device 17 for supply-fuel and collection-fuel quantities of the fuel station. Finally, considering the location information of the delivery vehicle 1 obtained by using a map information system, and the location information of each fuel station 2, a driving route to each fuel station is determined by a determination device 18 for a driving route of the delivery vehicle.

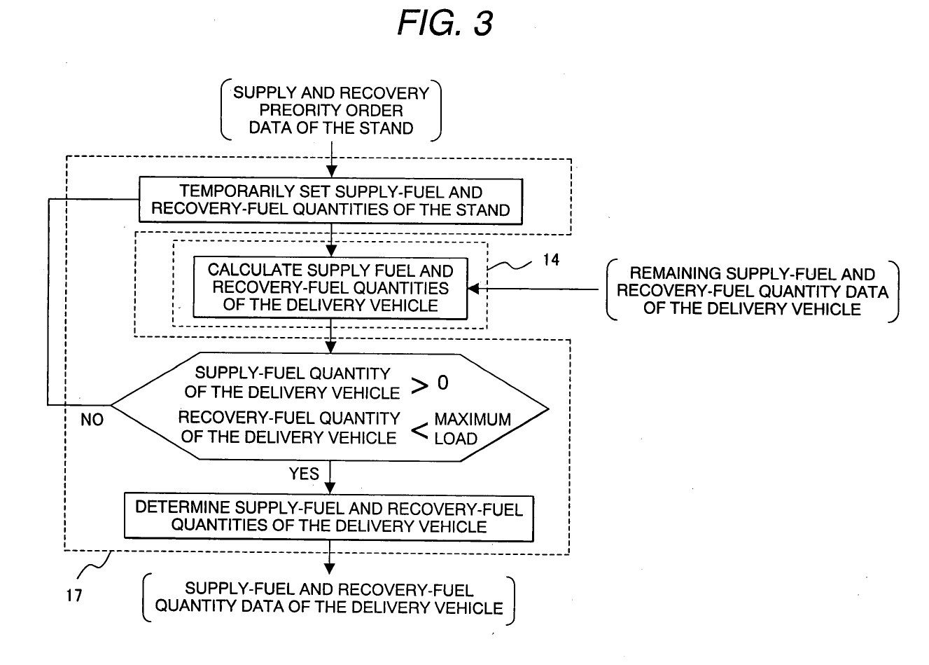

FIG. 3 is a flow chart showing the operation procedure for determining the supply-fuel and collection-fuel quantities of each fuel station in the first embodiment of the present invention.

In the determination device 17 for supply-fuel and collection-fuel quantities of the fuel station, from the supply and collection priority order data of each fuel station calculated by the calculation device 16 for supply and collection priority order of the fuel station, supply-fuel and collection-fuel quantities at each fuel station are temporarily set. Using the temporary values, the remaining supply-fuel and collection-fuel quantities of the delivery vehicle 1 are estimated by the estimation device 14 for remaining supply-fuel and collection-fuel quantities of the delivery vehicle. As a result, when the supply-fuel quantity of the delivery vehicle is 0 or higher and the collection-fuel quantity of the delivery vehicle is the maximum load or lower, the temporary supply-fuel and collection-fuel quantities at each fuel station are finalized as command values. When the above condition is not met, the temporary values are changed and the process is continued until the condition is satisfied.

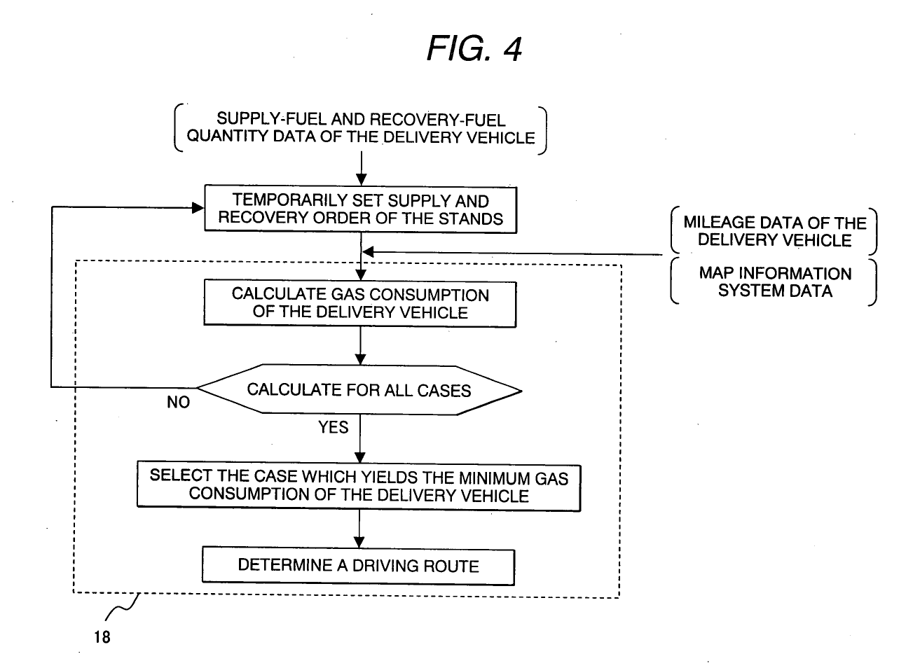

FIG. 4 is a flow chart showing the operation procedure for determining a driving route of the delivery vehicle in the first embodiment of the present invention.

In the determination device 18 for a driving route of the delivery vehicle, first, supply and collection order of the fuel stations is temporarily set. Since the weight of the delivery vehicle 1 between one fuel station and the next can be calculated from the supply-fuel and collection-fuel quantities of each fuel station calculated by the determination device 17 for supply-fuel and collection-fuel quantities of the fuel station, gas consumption of the delivery vehicle after stopping at each fuel station in the temporary supply and collection order is calculated using the mileage data of the delivery vehicle (mileage for the weight of the vehicle). At this point, with regard to a driving route between the fuel stations 2, the route which yields the least amount of gas consumption is selected using the location information of the delivery vehicle in a map information system, location information of each fuel station, and road information. The above calculation is performed for each permutation of all the supply and collection tanks requiring supply or collection (nPr ways, n: number of supply tanks+collection tanks, r: number of tanks requiring supply or collection), and the supply and collection order which yields the least amount of gas consumption of the delivery vehicle is selected from the results.

The above-mentioned flow chart describes for the case when the gas consumption of the delivery vehicle is to be minimum; however, when a driving time of the delivery vehicle is to be minimum, the driving time can be calculated for each permutation of all the supply and collection tanks requiring supply or collection, to select the supply and collection order which yields the least driving time.

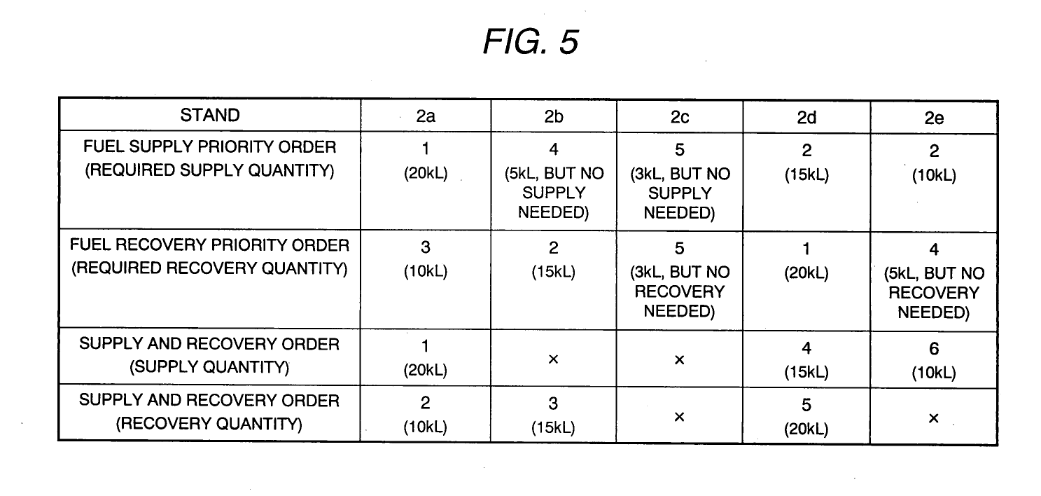

FIG. 5 shows a calculation example of supply-fuel and collection-fuel quantities of each fuel station in the first embodiment of the present invention.

For example, here describes a case where the delivery vehicle 1 circulates among fuel stations 2a, 2b, 2c, 2d, and 2e. From the estimated remaining supply-fuel quantity data of each fuel station, required supply quantities are calculated as 20 kL, 5 kL, 3 kL, 15 kL, and 10 kL, respectively. In this case, priority order for fuel supply will be 1, 4, 5, 2, and 3, respectively. In the same manner, from the estimated remaining collection-fuel quantity data of each fuel station, required collection quantities are calculated as 10 kL, 15 kL, 3 kL, 20 kL, and 5 kL, respectively. In this case, priority order for fuel collection will be 4, 2, 1, 5, and 3, respectively. This time, for the supply fuel, it is anticipated that fuel stations 2b and 2c, each requiring only a small amount of supply-fuel, have enough supply fuel until the next delivery. In addition, since the delivery vehicle has no supply capacity enough for all, the delivery vehicle skips the supply to fuel stations 2b and 2c. In the same manner, for the collection fuel, it is anticipated that fuel stations 2c and 2e, each having only a small amount of collection-fuel, have enough tank space until the next collection. Since the delivery vehicle has no collection capacity enough for all, according to the priority order, the delivery vehicle skips the collection at fuel stations 2c and 2e. Now, the delivery vehicle can bypass the fuel station 2c which requires neither supply nor collection, this time, and go to the rest of the fuel stations. Finally, a driving route to those fuel stations is determined from the location information of the delivery vehicle 1 and the location information of each fuel station; (in this case, gas consumption will be minimum if the delivery vehicle travels to 2a, 2b, 2d, and 2e in order.)

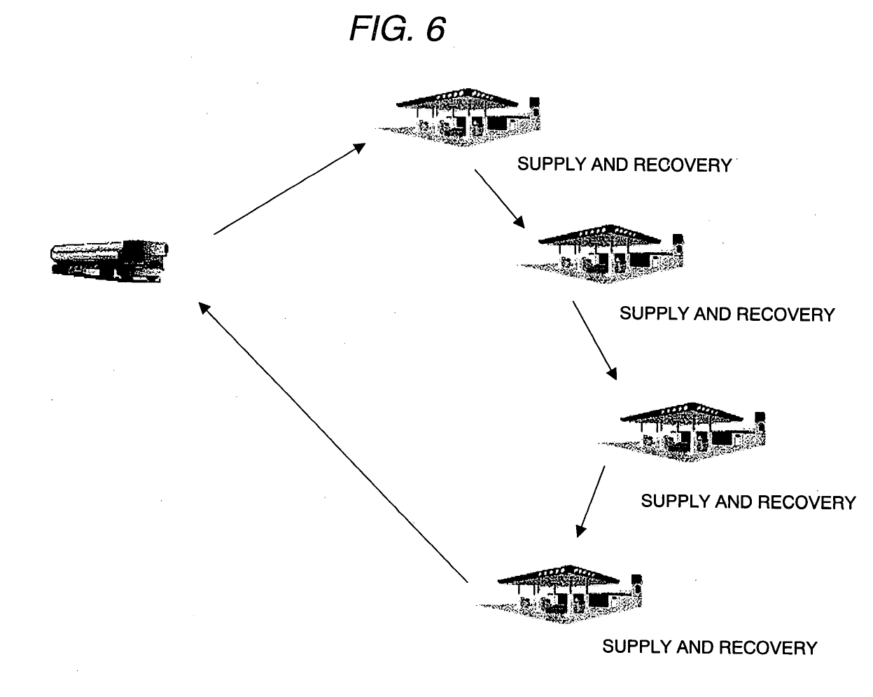

FIG. 6 shows an example of a supply and collection route for each fuel station in the first embodiment of the present invention. When circulating among the fuel stations in this way, the delivery vehicle supplies and collects fuels at each fuel station; (the fuel station requiring no supply or collection is bypassed.)

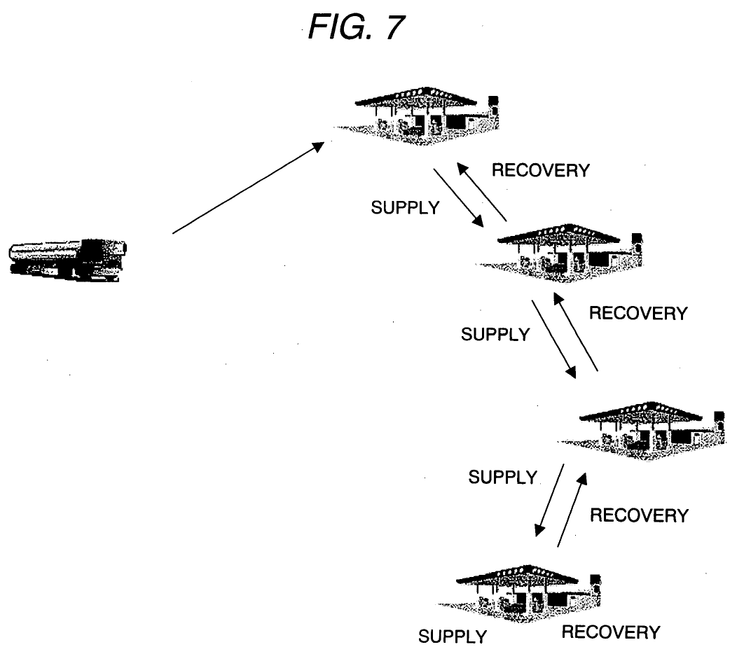

FIG. 7 shows another example of a supply and collection route for each fuel station in the first embodiment of the present invention. In this case, the geographical situation of the fuel stations makes the delivery vehicle return by a route close to the outward route. Consequently, the driving route is selected in which the delivery vehicle supplies fuel on the outward route and collects residual on the return route. The gas consumption can be reduced in this case since the mileage will improve as the delivery vehicle supplies the fuel, decreasing its weight.

In this embodiment, the organic hydride or liquid fuel containing the organic hydride can be supplied and collected quickly and efficiently since not only the driving route appropriate for the tank capacity of the driving vehicle can be determined but also the only essential supply and collection are performed.

### Embodiment 2

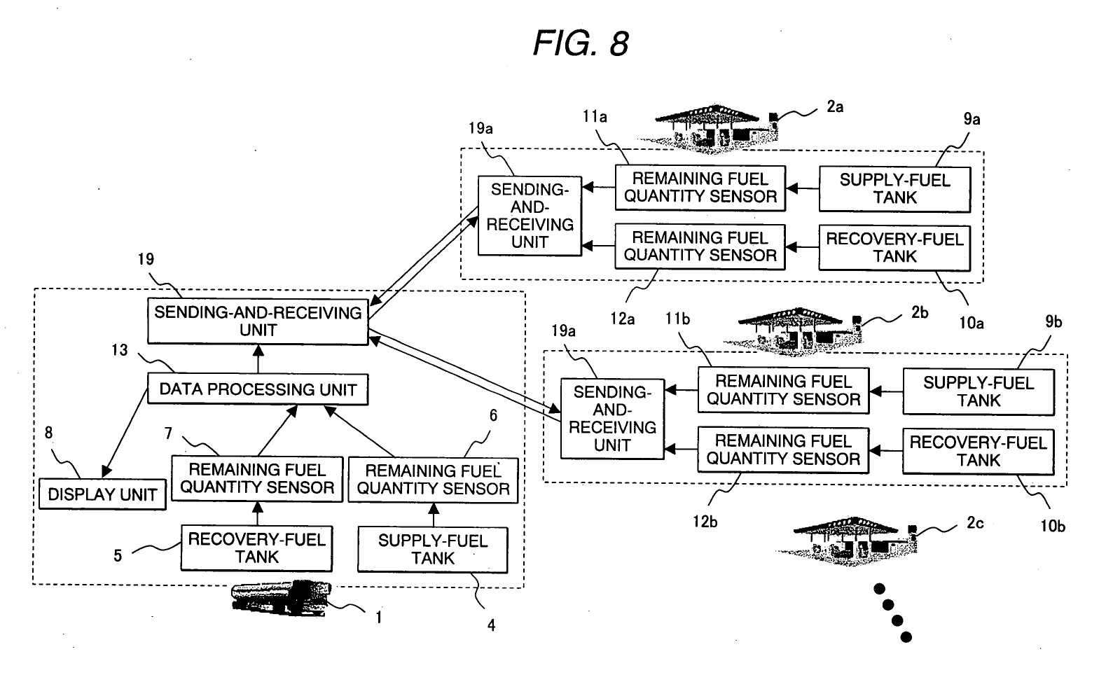

FIG. 8 is a supply and collection system for an organic hydride or liquid fuel containing an organic hydride showing the second embodiment of the present invention.

In this embodiment, the information processing apparatus 13 provided in the central information processing center 3 mentioned in the embodiment 1 is installed in the delivery vehicle 1. The information processing apparatus 13 to be installed in the delivery vehicle 1 has the same function as the information processing apparatus 13 provided in the central information processing center 3 in the embodiment 1.

The remaining supply-fuel quantity data and the remaining collection-fuel quantity data detected by the remaining supply-fuel quantity sensor 6 and the remaining collection-fuel quantity sensor 7 installed in the delivery vehicle 1 are sent to the information processing apparatus 13, and the remaining supply-fuel and collection-fuel quantities of the delivery vehicle 1 are estimated by the estimation device 14 for remaining supply-fuel and collection-fuel quantities. In the same manner, the remaining supply-fuel quantity data and the remaining collection-fuel quantity data detected by the remaining supply-fuel quantity sensor 11 and the remaining collection-fuel quantity sensor 12 installed in each fuel station 2 are sent to the information processing apparatus 13 of the delivery vehicle 1, and the remaining supply-fuel and collection-fuel quantities of each fuel station are estimated by the estimation device 15 for remaining supply-fuel and collection-fuel quantities. Then, in the same manner as in the embodiment 1, a driving route to each fuel station is determined by the calculation device 16 for supply and collection priority order of the fuel station, the determination device 17 for supply-fuel and collection-fuel quantities of the fuel station, and the determination device 18 for a driving route of the delivery vehicle 1; the result is displayed on the display unit 8 in the delivery vehicle 1. In this embodiment, in the same manner as in the embodiment 1, a sending-and-receiving apparatus is provided to each of the delivery vehicle and the fuel stations, and real-time data sending and receiving are assumed. However, a data memory unit may be added in each sending-and-receiving apparatus to have each piece of data temporarily stored in the data memory unit until it is sent or received at regular intervals.

Unlike the embodiment 1, this embodiment has an advantage that no central information processing center 3 is needed for retaining the installation space for the information processing apparatus 13.

As the organic hydride mentioned in the present invention, there are, for example, cyclohexane benzene, methylhexane toluene, dimethylhexane xylen, decalin naphthalene, 1-methyldecalin 1-methylnaphthalene, 2-methyldecalin 2-methylnaphthalene, 2-ethyldecalin, 2-ethylnaphthalene, and so on.

The same effect can be expected using fuel in which a plurality of organic hydrides listed above are mixed as the organic hydride described in the above embodiments. In addition, the same effect can also be expected using liquid fuel such as gasoline in which an organic hydride is mixed in as a part of the fuel.

What is claimed is:

1. A supply and collection system for an organic hydride or liquid fuel containing an organic hydride comprising:
a delivery vehicle having a supply-fuel tank, a collection-fuel tank, a remaining supply-fuel quantity sensor for detecting a remaining fuel quantity of the supply-fuel tank, a remaining collection-fuel quantity sensor for detecting a remaining fuel quantity of the collection-fuel tank, and a display unit;
a plurality of fuel stations having a supply-fuel tank, a collection-fuel tank, a remaining supply-fuel quantity sensor for detecting a remaining fuel quantity of the supply-fuel tank, and a remaining collection-fuel quantity sensor for detecting a remaining fuel quantity of the collection-fuel tank; and a central information processing center having an information processing apparatus;
wherein, the remaining supply-fuel and collection-fuel quantities of the delivery vehicle and the remaining supply-fuel and collection-fuel quantities of each fuel station are estimated in the information processing apparatus from remaining supply-fuel quantity data and remaining collection-fuel quantity data detected in the delivery vehicle and remaining supply-fuel quantity data and remaining collection-fuel quantity data detected at each of the fuel station;
supply and collection priority order of each fuel station is calculated from the estimated remaining supply-fuel and collection-fuel quantity data of each fuel station;
a driving route of the delivery vehicle is determined based on the estimated remaining supply-fuel and collection-fuel quantity data of the delivery vehicle and the supply and collection priority order of each fuel station; and
the determined driving route is displayed on the display unit in the delivery vehicle.

2. The supply and collection system according to the claim 1, wherein the fuel is an organic hydride.

3. The supply and collection system according to the claim 1, wherein the fuel contains an organic hydride mixed in as a part of the fuel.

4. The supply and collection system according to the claim 1, wherein the control processing apparatus has an estimation device for remaining supply-fuel and collection-fuel quantities of the fuel station, a calculation device for supply and collection order of the fuel station, an estimation device for remaining supply-fuel and collection-fuel quantities of the delivery vehicle, and collection-fuel quantities of the fuel station, and a determination device for a driving route of the delivery vehicle.

5. The supply and collection system according to the claim 1, wherein
the driving route of the delivery vehicle is determined based on location information of the delivery vehicle and the each fuel station, and the supply-fuel and the collection-fuel quantities of the fuel station which are determined based on the estimated remaining supply-fuel and collection-fuel quantity data of the delivery vehicle and the supply and collection priority order of each fuel station.

6. The supply and collection system according to the claim 1, wherein
the driving route of the delivery vehicle is determined based on location information of the delivery vehicle and the each fuel station, and the supply-fuel and the collection-fuel quantities of the fuel station which are determined based on the estimated remaining supply-fuel and collection-fuel quantity data of the delivery vehicle and the supply and collection priority order of each fuel station, and
the control processing apparatus has an estimation device for remaining supply-fuel and collection-fuel quantities of the fuel station, a calculation device for supply and collection order of the fuel station, an estimation device for remaining supply-fuel and collection-fuel quantities of the delivery vehicle, a determination device for supply-fuel and collection-fuel quantities of the fuel station, and a determination device for a driving route of the delivery vehicle.

7. A supply and collection system for an organic hydride or liquid fuel containing an organic hydride comprising:
a delivery vehicle having a supply-fuel tank, a collection-fuel tank, a remaining supply-fuel quantity sensor for detecting a remaining fuel quantity of the supply-fuel tank, a remaining collection-fuel quantity sensor for detecting a remaining fuel quantity of the collection-fuel tank, an information processing apparatus, and a display unit; and
a plurality of fuel stations having a supply-fuel tank, a collection-fuel tank, a remaining supply-fuel quantity sensor for detecting a remaining fuel quantity of the supply-fuel tank, and a remaining collection-fuel quantity sensor for detecting a remaining fuel quantity of the collection-fuel tank;
wherein, from remaining supply-fuel quantity data and remaining collection-fuel quantity data detected in the delivery vehicle and remaining supply-fuel quantity data and remaining collection-fuel quantity data detected at each of the fuel stations,
the remaining supply-fuel and collection-fuel quantities of the delivery vehicle and the remaining supply-fuel and collection-fuel quantities of each fuel station are estimated in the information processing apparatus;
supply and collection priority order of each fuel station is calculated from the estimated remaining supply-fuel and collection-fuel quantity data of each fuel station;
a driving route of the delivery vehicle is determined based on the estimated remaining supply-fuel and collection-fuel quantity data of the delivery vehicle and the supply and collection priority order of each fuel station; and
the determined driving route is displayed on the display unit in the delivery vehicle.

8. The supply and collection system according to the claim 7, wherein the fuel is an organic hydride.

9. The supply and collection system according to the claim 7, wherein the fuel contains an organic hydride mixed in as a part of the fuel.

10. The supply and collection system according to the claim 7, wherein the control processing apparatus has an estimation device for remaining supply-fuel and collection-fuel quantities of the fuel station, a calculation device for supply and collection order of the fuel station, an estimation device for remaining supply-fuel and collection-fuel quantities of the delivery vehicle, a determination device for supply-fuel and collection-fuel quantities of the fuel station, and a determination device for a driving route of the delivery vehicle.

11. The supply and collection system according to the claim 7, wherein
the driving route of the delivery vehicle is determined based on location information of the delivery vehicle and the each fuel station, and the supply-fuel and the collection-fuel quantities of the fuel station which are determined based on the estimated remaining supply-fuel and collection-fuel quantity data of the delivery vehicle and the supply and collection priority order of each fuel station.

12. The supply and collection system according to the claim 7, wherein
the driving route of the delivery vehicle is determined based on location information of the delivery vehicle and the each fuel station, and the supply-fuel and the collection-fuel quantities of the fuel station which are determined based on the estimated remaining supply-fuel and collection-fuel quantity data of the delivery vehicle and the supply and collection priority order of each fuel station, and
the control processing apparatus has an estimation device for remaining supply-fuel and collection-fuel quantities of the fuel station, a calculation device for supply and collection order of the fuel station, an estimation device for remaining supply-fuel and collection-fuel quantities of the delivery vehicle, a determination device for supply-fuel and collection-fuel quantities of the fuel station, and a determination device for a driving route of the delivery vehicle.
